(19) United States
(12) Patent Application Publication
(10) Pub. No.: US 2023/0157258 A1
(43) Pub. Date: May 25, 2023

(54) Pet feeder

(71) Applicant: Dongguan Jiasheng Enterprise Co., Ltd, Guangdong (CN)

(72) Inventor: Silong Chen, Guangdong (CN)

(21) Appl. No.: 17/646,454

(22) Filed: Dec. 29, 2021

(30) Foreign Application Priority Data
Nov. 19, 2021 (CN) 202130765488.8

(51) Int. Cl. A01K 5/02

(52) U.S. Cl. CPC A01K 5/0225

(57) ABSTRACT

A pet feeder comprises a grain storage mechanism and a grain releasing mechanism; the grain storage mechanism is used for storing grain and provided with an outlet; the grain releasing mechanism is mounted on the grain storage mechanism at a position closed to the outlet; the grain releasing mechanism can deliver a grain in the grain storage mechanism to the outlet and close the outlet after the grain flows out from the outlet, so that the other animals such as roaches can not enter the grain storage mechanism from the outlet, thereby protecting the gain in the rain storage mechanism from waste and pollution.

### FIELD OF THE INVENTION

The present invention relates to pet supplies technical field, more particularly, relates to a kind of pet feeder.

### BACKGROUND OF THE INVENTION

As living standards improve, more and more families keep their pets. When people go work or leave home and can not feed their pets on time, they usually put grain in grain basins before they leave so that the pets can eat by themselves. But this may lead the pets to eat irregularly, resulting in pet indigestion and unnecessary feeding burden to the owner. Using the pet feeders, the owners can feed the pets regularly and quantitatively when the they are not at home.

However, the pet feeder in the prior art has the below deficiencies: the outlet of the pet feeder is not strictly closed so that the pets can open it easily to eat the grain in the pet feeder and the other animals such as roaches can enter the pet feeder from the outlet to eat pet food, resulting in waste and pollution of grain.

### SUMMARY OF THE INVENTION

The object of the present invention is to provide a pet feeder to solve the deficiencies that the outlet of the pet feeder is not strictly closed so that the animals such as roaches can easily enter the pet feeder from the outlet to eat grain in it, resulting in waste and pollution of the grain.

In order to achieve the object, the present invention provides a pet feeder, which includes a grain storage mechanism and a grain releasing mechanism. The grain storage mechanism is used for storing grain and provided with an outlet, the grain releasing mechanism is mounted on the grain storage mechanism and closed to the outlet. The grain releasing mechanism can deliver the grain in the grain storage mechanism to the outlet and close the outlet after the grain flows out from the outlet.

Optionally, the grain storage mechanism includes a bottom shell, the bottom shell is provide with a mounting housing, the outlet is provided on an outer wall of the bottom shell and is communicated with the mounting housing. The grain releasing mechanism includes a rotary disc and a driving assemble. The rotary disc is rotatably mounted in the mounting housing, the the rotary disc is provided with at least a grain tank and a block. The driving assemble is connected with the rotary disc and drives it to rotate. When the grain is released, the grain tank delivers the grain to the outlet, when the outlet is closed, the block moves to the outlet and closes it.

Optionally, the rotary disc is provided with at least a plurality of the blocks, the grain tank is formed between adjacent two of the blocks.

Optionally, an central of the rotary disc is provided with a connecting shaft, rotatably connected to the bottom shell. The driving assemble is connected with the connecting shaft and drives it to rotate.

Optionally, the grain storage mechanism includes a grain storage bucket with a grain cavity, the lower part of the grain storage bucket is provided with a connecting shell covering on the bottom shell. The interior of the connecting shell is provided with an inlet communicated with the grain cavity and the mounting housing.

Optionally, the interior of the connecting shell is provided with a scratching piece above the rotary disc, the bottom of the scratching piece is close to the rotary disc, the scratching piece separates the interior of the connecting shell into an anterior cavity and a posterior cavity. The inlet lies at the posterior cavity, the outlet lies at a side of the anterior cavity. When the rotary disc rotates, the scratching piece blocks the grain beyond the grain tank.

Optionally, the grain tank passes through the rotary disc. The outlet includes a first outlet and a second outlet arranged respectively on a side wall and a bottom wall of the bottom shell. The first outlet is connected with the second outlet and both are corresponding to the grain tank.

Optionally, the side wall of the rotary disc is provided with arc convex bars closed to an inner wall of the mounting housing.

Optionally, the pet feeder also includes an outer shell. The grain storage mechanism and the grain releasing mechanism both are arranged in the outer shell. The outer shell is provided with an inclined downward channel, an upper end of the channel is connected with the outlet, a lower end of the channel extends out the outer shell.

Optionally, the pet feeder also includes a plate for receiving the grain flowing out from the outlet.

Compared with the prior art, one or more or more of the above pet feeders provided in embodiments of the present invention have at least one of the following technical effects:

In releasing the grain, the grain releasing mechanism can deliver the grain in the grain storage mechanism to the outlet, then the grain flows out of the outlet for the pet eating. After the grain flows out, the grain releasing mechanism can close the outlet strictly so that the other animals such as roaches can not enter the grain storage mechanism from the outlet, thereby protecting the gain in the rain storage mechanism from waste and pollution.

### BRIEF DESCRIPTION OF THE DRAWINGS

In order to more clearly illustrate the technical schemes in the embodiments in the present invention, the drawings needed in the embodiments or the prior technical description are briefly introduced below. Obviously, the drawings described below are only some embodiments in the present invention, and for those skilled in the art, additional drawings may be obtained according to the drawings below without creative work.

FIG. 1 is a perspective view of the pet feeder according to the present invention.

FIG. 2 is an insection view of the pet feeder according to the present invention.

FIG. 3 is an insection view of a part of the pet feeder according to the present invention.

FIG. 4 is a part perspective view of the pet feeder according to the present invention.

FIG. 5 is a decomposition view of the pet feeder according to the present invention.

### DETAILED DESCRIPTION OF ILLUSTRATED EMBODIMENTS

In order to make the invention purpose, the technical scheme and the technical effect more clearly be understood, the invention is further explained in combination with the concrete embodiment below. It should be understood that the specific embodiments described herein are only used to interpret the invention and are not used to limit the invention.

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limits.

In the embodiments of the invention, unless otherwise clearly specified and defined, the terms, “installed”, “connected”, “or” fixed should be generally understood, for example, a fixed connection, or a removable connection, a mechanical connection or an electrical connection, or an directly connection or an indirectly connection through an intermediate media, or a connection within two elements or the interaction of two elements. For those of ordinary skilled in the art, the specific meaning of the above terms in the embodiment of the present invention may be understood under specific circumstances.

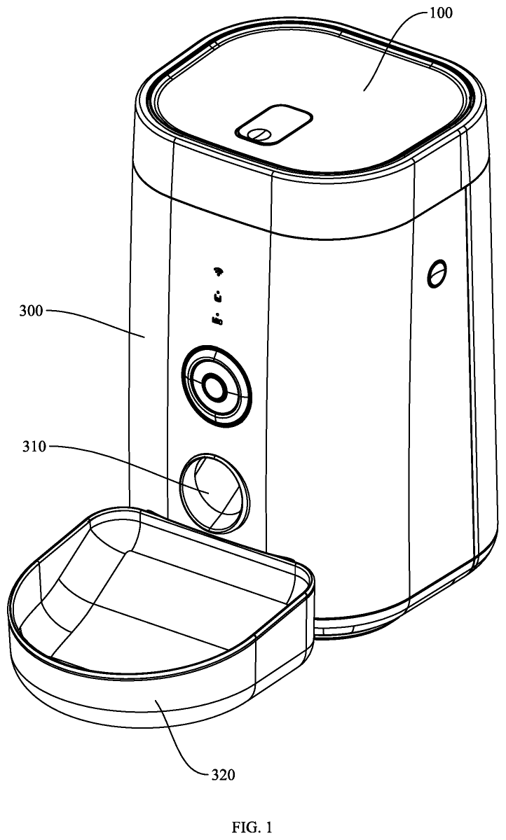

Referring to FIG. 1 to FIG. 3, in one embodiment of the present invention, referring to FIGS. 1-5, a pet feeder includes a grain storage mechanism 100 and a grain releasing mechanism 200.

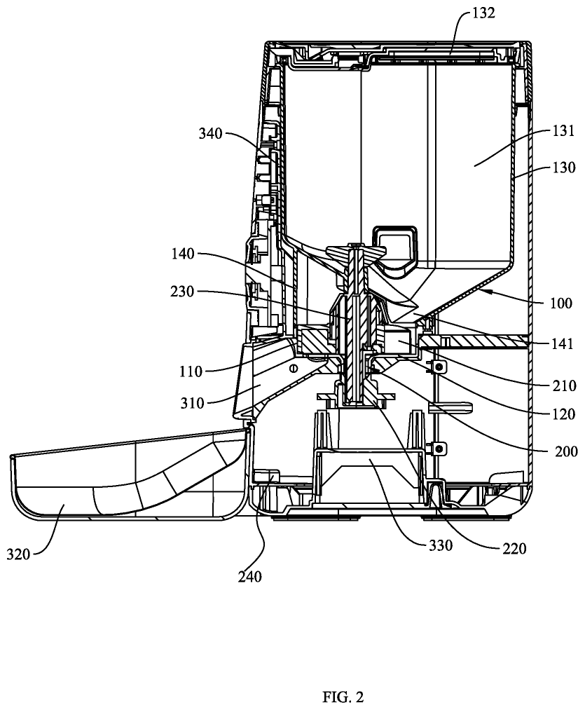

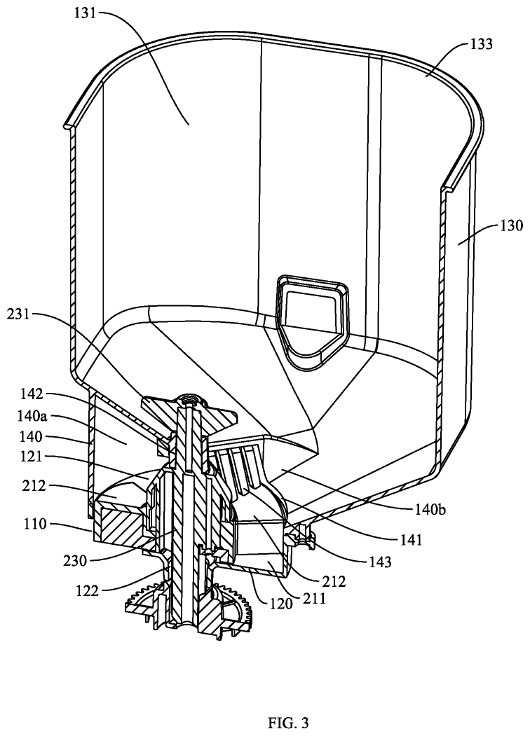

Referring to FIG. 2 and FIG. 3, the grain storage mechanism 100 is used for storing grain and provided with an outlet 110. The grain releasing mechanism 200 is mounted on the grain storage mechanism 100 at a position closed to the outlet 110. The grain releasing mechanism 200 can deliver the grain in the grain storage mechanism 100 to the outlet 110 and close the outlet 110 after the grain flows out from the outlet 110.

Referring to FIG. 2 and FIG. 3, in releasing the grain, the grain releasing mechanism 200 can deliver the grain in the grain storage mechanism 100 to the outlet 110, then the grain flows out of the outlet 110 for the pet eating. After the grain flows out, the grain releasing mechanism 200 can close the outlet 110 strictly so that the other animals such as roaches can not enter the grain storage mechanism 100 from the outlet 110, thereby protecting the gain in the rain storage mechanism 100 from waste and pollution.

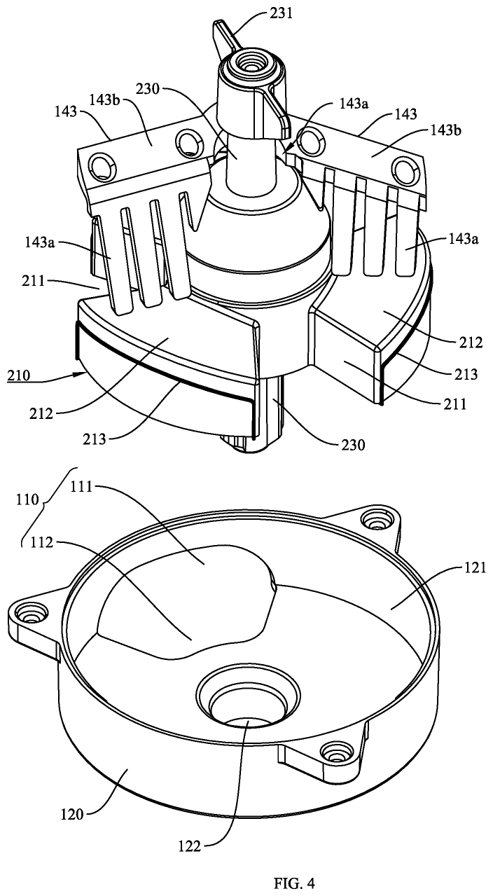

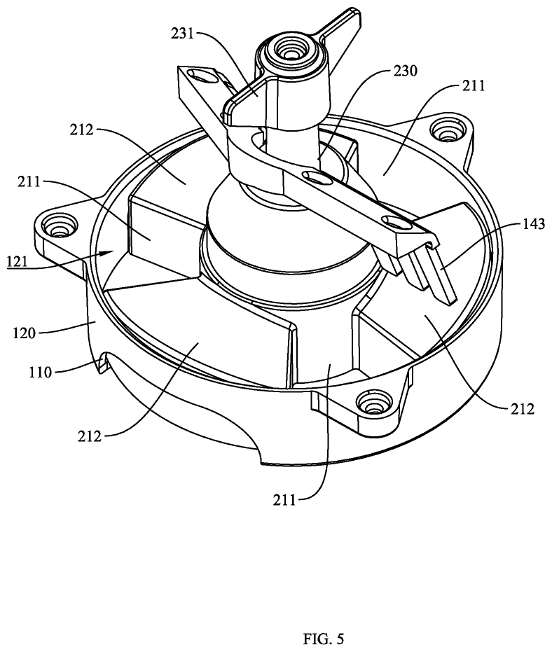

In one embodiment of the present invention, referring to FIG. 3, FIG. 4 and FIG. 5, the grain storage mechanism 100 includes a bottom shell 120. The bottom shell 120 is provided with a mounting housing 121, the outlet 110 is provided on the bottom shell 120 and is communicated with the mounting housing 121. The mounting housing 121 is in a cylindrical shape.

Referring to FIG. 3, FIG. 4 and FIG. 5, the grain releasing mechanism 200 includes a rotary disc 210 and a driving assemble 240. The rotary disc 210 is contained in the mounting housing 121 and is rotatably mounted in it, the rotary disc 210 is provided with at least a grain tank 211 and at least a block 212. The driving assemble 240 is connected with the rotary disc 210 and drives it to rotate.

Referring to FIG. 3, FIG. 4 and FIG. 5, when releasing the grain, the grain in the gain storage mechanism 100 is delivered to the grain tank 211, the driving assemble 240 drives the rotary disc 210 to rotate so that the grain tank 211 delivers the grain to the outlet 110. Then the grain flows out from the outlet 100 for the pet to eat. When closing the outlet 110, the driving assemble 240 drives the rotary disc 210 to rotate so that the block 212 moves to the outlet 110 and closes it. The pets can not move the block 212, the outlet 110 is closed strictly and the gain can not flow out. At the same time, the other animals such as the roaches can not enter the gain storage mechanism 100 from the outlet 10, thereby protecting the grain in the grain storage mechanism 100.

Further, referring to FIG. 3, FIG. 4 and FIG. 5, the rotary disc 210 is provided with a plurality of the blocks 212, the grain tank 211 is formed between adjacent two of the blocks 212. The rotary disc 210 is roughly in a fan shape. Specifically, the number of the block 212 is three, correspondingly, the number of the grain tank 211 is three.

Further, referring to FIG. 3, FIG. 4 and FIG. 5, the centre of the rotary disc 210 is provided with a connecting shaft 230, rotatably connected to the bottom shell 120 so that the rotary disc 210 is rotatably mounted in the mounting housing 121 and stably rotates. The driving assemble 240 is connected with the connecting shaft 230 and drives it to rotate, thereby rotating the rotary disc 210. The rotary disc 210 has a simple structure and can rotate stably.

Further, referring to FIG. 3, FIG. 4 and FIG. 5, the rotary disc 210 can fixed on the connecting shaft 230 by screw connection, bonding connection and the like.

Specifically, in one embodiment of the present invention, referring to FIG. 3, FIG. 4 and FIG. 5, the driving assemble 240 is gear motor, a shaft of the gear motor is fixed with the connecting shaft 230, the gear motor drives the connecting shaft 230 to rotate. In some other embodiments, the driving assemble 240 includes a motor and a gear 220 sleeved at the lower end of the connecting shaft 230. A shaft of the motor is provided with a first gear meshed with the gear 220. The motor drives the connecting shaft 230 to rotate by the first gear and the gear 220.

In one embodiment of the present invention, referring to FIG. 3, FIG. 4 and FIG. 5, the grain storage mechanism 100 includes a grain storage bucket 130 with a grain cavity 131. The grain is stored in the grain cavity 131.

In one embodiment of the present invention, referring to FIG. 3, FIG. 4 and FIG. 5, the lower part of the grain storage bucket 130 is provided with a connecting shell 140, the mounting housing 121 is formed an inlet at its upper end. The connecting shell 140 covers on the bottom shell 120, and the connecting shell 140 is communicated with the mounting housing 121.

Further, the connecting shell 140 can be connected with the bottom shell 120 by screw connection, bonding connection and the like.

Referring to FIG. 3, FIG. 4 and FIG. 5, the interior of the connecting shell is provided with an inlet 141 communicated with the grain cavity 131 and the mounting housing 121. The grain in the grain cavity 131 is delivered through the inlet 141 to the grain tank 211 in the mounting housing 121 under the gravity. Then the rotary disc 210 is rotated, and the grain in the grain tank 211 is delivered to the outlet 110.

Further, referring to FIG. 3, FIG. 4 and FIG. 5, the bottom centre of the mounting housing 121 is provided with a first mounting hole 122. The top centre of the the connecting shell 140 is provided with a second mounting hole 142. The two end of the connecting shaft 230 are connected rotatably with the first mounting hole 141 and the second mounting hole 142. The installation of the connecting shaft is stable.

Further, referring to FIG. 3, FIG. 4 and FIG. 5, the top of the connecting shaft 230 is provided with a cover 231, larger than the second mounting hole 142, acting as a limit to prevent the connecting shaft 230 from taking off from the second mounting hole 142.

Wherein, the driving assemble 240 is connected to the lower end of the connecting shaft 230 and drives it to rotate.

In one embodiment of the present invention, referring to FIG. 3, FIG. 4 and FIG. 5, the interior of the connecting shell 140 is provided with a scratching piece 143 above the rotary disc 210, the bottom of the scratching piece 143 is close to the rotary disc 210. The scratching, piece 143 separates the interior of the connecting shell into an anterior cavity 140a and a posterior cavity 140b. The inlet 141 lies at the posterior cavity 140b, the outlet 110 lies at a side of the anterior cavity 140a. When the rotary disc 210 rotates and the grain passes the scratching piece 143, the scratching piece 143 blocks the grain beyond the grain tanks 211 so that the grain delivered through the grain tank 211 to the outlet 110 is just the capacity of one of the grain tanks 211, that is to say each time the amount of the grain output from the outlet 110 is the capacity of one grain tank 211, thereby realizing the quantitative delivery of the grain, which avoids the phenomenon of uneven amount of pet grain.

Referring to FIG. 3, FIG. 4 and FIG. 5, the scratching piece 143 includes multiple scraping strips 143a arranged in a line and formed in a comb shape. The gaps between adjacent two scraping strips 143a are less than the size of the grain so as to avoid the grain passes the gaps. The scratching piece 143 is set in a comb shape, when the scratching piece 143 blocks the grain, it also can guide the grain to be arranged orderly, so that it is not easy to jam.

Referring to FIG. 3, FIG. 4 and FIG. 5, the top of the scraping piece 143 extends a mounting plate 143b fixed with the connecting shell 140 by screws, it is easy to install. Wherein, the middle of the scraping piece 143 has an avoiding position 143a for the connecting shaft 230.

Referring to FIG. 3, FIG. 4 and. FIG. 5, the grain tank 211 passes through the rotary disc 210, the outlet 110 includes a first outlet 111 and a second outlet 112 at the side wall and the bottom wall of the bottom shell 120 respectively. The first outlet 111 and the second outlet 112 are connected, when the rotary disc 210 moves to the outlet 110 with the grain tanks 211, the first outlet 111 and the second outlet 112 are corresponding with the grain tanks 211.

Specifically, referring to FIG. 3, FIG. 4 and FIG. 5, because the grain tank 211 passes through the rotary disc 210, it is convenient for the grain in the grain cavity 131 of the grain storage mechanism 100 enters the grain tank 211 from the inlet 141 and the grain tank 211. Simultaneously, when the grain is delivered, the rotary disc 210 brings the grain tank 211 to the outlet 110, so that the grain in the grain tank 210 is delivered from the first outlet 111 and the second outlet 112. It is not easy to dam and convenient for the pets to eat.

Further, referring to FIG. 3, FIG. 4 and FIG. 5, the side wall of the rotary disc 210 is provided with arc convex bars 213 closed to the inner wall of the mounting housing 121. When the rotary disc 210 rotates, the arc convex bars 213 contacts with the inner wall of the mounting housing 121 to protect the rotary disc 210 to rotate stably in the mounting housing 121. And the contacting area of the arc convex bars 213 and the inner wall of the mounting housing 121 is less so that the friction between them are reduced, the resistance is reduced, the wear is reduced, and the movement is smooth.

In one embodiment of the present invention, referring to FIG. 3, FIG. 4 and FIG. 5, the pet feeder also includes an outer shell 300. The grain storage mechanism 100 and the grain releasing mechanism 200 both are arranged in the outer shell 300. The outer shell 300 is provided with an inclined downward channel 310, an upper end of the channel 310 is connected with the outlet 110, a lower end of the channel 310 extends out the outer shell 300. The channel 310 has the function of feeding, and the grain flowing out from the outlet 110 is transported to an outside of the outer shell 300 along the channel 310. Simultaneously, the outlet 110 is arranged in the outer shell 300, the channel 310 is long enough to protect the outlet from touching by the pets, thereby that the pets can not easily touch the block 212 and move the block 212.

Specifically, referring to FIG. 1 and FIG. 2, the channel 310 is tubular tubular, which is convenient for conveying the grain. Preferably, the channel 310 is circular tubular.

In another embodiment of the present invention, referring to FIG. 1, FIG. 2 and FIG. 3, the top of the grain storage bucket 130 is provided with an opening 133 and a top cover 132 matched with the opening 133. When the top cover 132 is moved, the grain can be put into the grain storage bucket 130 through the opening 133. When the top cover 132 covers the opening 133, the opening 133 is closed.

Specifically, in some embodiments, a side of the top cover 132 is connected with the grain storage bucket 130 at a side of the opening 133 by a shaft or a hinge, the top cover 132 can be opened and closed the opening by rotation. In some other embodiments, the top cover 132 is not connected with the outer shell 130, it is a separated structure from the outer shell 130. The user can take the top cover 132 from the outer shell 130 or covers it on the outer shell 130.

Further, referring to FIG. 1 and FIG. 2, the pet feeder also includes a plate 320 for receiving the grain flowing out from the outlet 110. The grain in the outlet 110 delivers to the plate 320 along the channel 310 under its gravity. The plate 320 is convenient for pets to eat the grain

Wherein, the plates is mounted on the outer shell 300 below the channel 310 by card connection, screw connection, etc.

In some embodiments according to the present invention, referring to FIG. 1 and FIG. 2, the outer shell 300 is provided with a battery warehouse 330. The battery warehouse 330 is used for containing a battery which is coupled electrically with the driving assemble 240. The battery supplies power for the driving assemble 240.

Referring to FIG. 1 and FIG. 2, the out shell 300 is provided with a electric control assemble 340. The driving assemble 240 and the battery are coupled electrically with the electric control assemble 340. The electric control assemble 340 may be a PLC, an integrated chip, or an integrated circuit board according to desired. The electric control assemble 340 belongs to the prior art that those skilled in the prior art should know, therefor the present invention is not describe the principle.

The above are only better embodiments of the invention and are not used to limit the invention, and any modifications, equivalent replacements, and improvements made within the spirit and principles of the invention shall be included within the protection of the invention. The above are only better embodiments of the invention and are not used to limit the invention, and any modifications, equivalent replacements, and improvements made within the spirit and principles of the invention shall be included within the protection of the invention.

What is claimed is:

1. A pet feeder, comprising a grain storage mechanism and a grain releasing mechanism; said grain storage mechanism is used for storing a grain and provided with an outlet; said grain releasing mechanism is mounted on said grain storage mechanism at a position closed to said outlet; said grain releasing mechanism can deliver the grain in said grain storage mechanism to said outlet and close said outlet after said grain flows out from said outlet; wherein,
said grain storage mechanism includes a bottom shell, said bottom shell is provide with a mounting housing, said outlet is provided on said bottom shell and is communicated with said mounting housing; said grain releasing mechanism includes a rotary disc and a driving assemble; said rotary disc is rotatably mounted in said mounting housing, said rotary disc is provided at least with a grain tank and a block; said driving assemble is connected with said rotary disc and drives it to rotate; when said food is released, said grain tank delivers said grains to said outlet, when said outlet is closed, said block moves to said outlet and closes it.

2. The pet feeder according to said claim 1, wherein said rotary disc is provided with a plurality of said blocks, said grain tank is formed between adjacent two of said blocks.

3. The pet feeder according to said claim 2, wherein a centre of said rotary disc is provided with a connecting shaft, rotatably connected to said bottom shell, said driving assemble is connected with said connecting shaft and drives it to rotate.

4. The pet feeder according to said claim 2, wherein said grain storage mechanism includes a grain storage bucket with a grain cavity, said lower part of said grain storage bucket is provided with a connecting shell covering on said bottom shell; an interior of said connecting shell is provided with an inlet communicated with said grain cavity and said mounting housing.

5. The pet feeder according to said claim 4, wherein said interior of said connecting shell is provided with a scratching piece above said rotary disc, a bottom of said scratching piece is close to said rotary disc, said scratching piece separates said interior of said connecting shell into an anterior cavity and a posterior cavity; said inlet lies at said posterior cavity, said outlet lies at a side of said anterior cavity; when said rotary disc rotates, said scratching piece blocks said grain beyond said grain tank.

6. The pet feeder according to said claim 2, wherein said grain tank passes through said rotary disc; said outlet includes a first outlet and a second outlet arranged respectively on a side wall and a bottom wall of said bottom shell; said first outlet is connected with said second outlet and both are corresponding to said grain tank.

7. The pet feeder according to said claim 6, wherein said scratching piece includes multiple scraping strips arranged in a line and formed in a comb shape; gaps between adjacent two scraping strips are less than a size of said grain.

8. The pet feeder according to said claim 2, wherein a side wall of said rotary disc is provided with arc convex bars closed to an inner wall of said mounting housing.

9. The pet feeder according to said claim 2, wherein also comprising an outer shell; said grain storage mechanism and said grain releasing mechanism both are arranged in said outer shell; said outer shell is provided with an inclined downward channel, an upper end of said inclined downward channel is connected with said outlet, a lower end of said inclined downward channel extends out said outer shell.
